(19) United States
(12) Patent Application Publication
(10) Pub. No.: US 2008/0164686 A1
(43) Pub. Date: Jul. 10, 2008

(54) SYSTEM AND METHOD FOR RETAINING MEMENTOES

(76) Inventor: Christine Johnson, Phoenix, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 11/969,730

(22) Filed: Jan. 4, 2008

Related U.S. Application Data
(60) Provisional application No. 60/883,383, filed on Jan. 4, 2007.

(51) Int. Cl. B42D 1/08

(52) U.S. Cl. 281/22

(57) ABSTRACT

A storage system for retaining mementoes and for reminding a user of specific dates and methods of using the system are disclosed. The system includes a book portion, which includes multiple sets of adjoining pages, where one of the pages includes a compartment, such as an envelope, and the other page is initially substantially blank, and a storage container.

### CROSS-REFERENCE TO RELATED APPLICATIONS

This application claims the benefit of U.S. Provisional Application Ser. No. 60/883,383, entitled SYSTEM AND METHOD FOR RETAINING MEMENTOES, filed Jan. 4, 2007.

### FIELD OF THE INVENTION

This invention generally relates to storage systems, and more particularly, to storage systems that include a means to remind a user to perform a function and to store material related to the function.

### BACKGROUND OF THE INVENTION

Storage systems for retaining mementoes and the like have long been known. Exemplary systems often include boxes, into which the mementoes are placed, or books such as photo albums or scrapbooks, into which mementoes are often placed onto various pages.

Although such systems work relatively well for their intended purpose, the systems generally do not include indicia to remind users of certain anniversaries or other dates and are often not theme (e.g., wedding, marriage, birth) specific. Accordingly, improved systems and methods of storing and organizing information are desired.

### SUMMARY OF THE INVENTION

The present invention provides an improved system for retaining mementoes for predefined events. While the ways in which the present invention addresses the various drawbacks of the prior art are discussed in greater detail below, in general, the present invention provides a system that includes storage compartments for collecting items associated with predefined dates.

In accordance with various embodiments of the invention, a system includes a book and a storage container. The book includes a plurality of pages having two surfaces. One surface of each page includes a compartment for storing memorabilia, such as a letter, and each compartment has a corresponding date, such as an anniversary, birth date, or the like. The other surface may be used to write on and/or to attach photographs or the like. The container may be in the form of a box and may be used to store writing utensils, stationery, photographs, photo corners, charms, and the like.

In accordance with one embodiment of the invention, a system includes a book, a storage container, and a sleeve. The book and storage container fit within the sleeve for convenient handling and storage of the book and container.

In accordance with another embodiment of the invention, a system includes a book and a container that are substantially the same size in at least two dimensions, and the container and book are bound together using a strap or the like.

In accordance with yet another embodiment of the invention, a system includes a book, a storage container, and a case that folds over and secures the book and the container. In accordance with various aspects of this embodiment, a portion of the case is fixedly attached to one of the books and the container.

### BRIEF DESCRIPTION OF THE DRAWINGS

FIG. 1 illustrates a front view of a system in accordance with one embodiment of the invention;

FIG. 2 illustrates a portion of an exemplary book in accordance with various exemplary embodiments of the invention;

FIG. 3 illustrates an exemplary storage container in accordance with various embodiments of the invention;

FIG. 4 illustrates an exemplary cover in accordance with various embodiments of the invention;

FIGS. 5 and 6 illustrate a system in accordance with another embodiment of the invention; and

FIG. 7 illustrates a cover in accordance with various embodiments of the invention; and

FIG. 8 illustrates another system in accordance with various embodiments of the invention.

Skilled artisans will appreciate that elements in the figures are illustrated for simplicity and clarity and have not necessarily been drawn to scale. The dimensions of some of the elements in the figures may be exaggerated relative to other elements to help to improve understanding of embodiments of the present invention.

### DETAILED DESCRIPTION

The following description is of exemplary embodiments only and is not intended to limit the scope, applicability or configuration of the invention in any way. Rather, the following description provides a convenient roadmap for implementing exemplary embodiments of the invention. Various changes to the described embodiments may be made in the function, steps, sizes, and proportions of the various system elements, without departing from the scope of the invention as set forth in claims and their requirements.

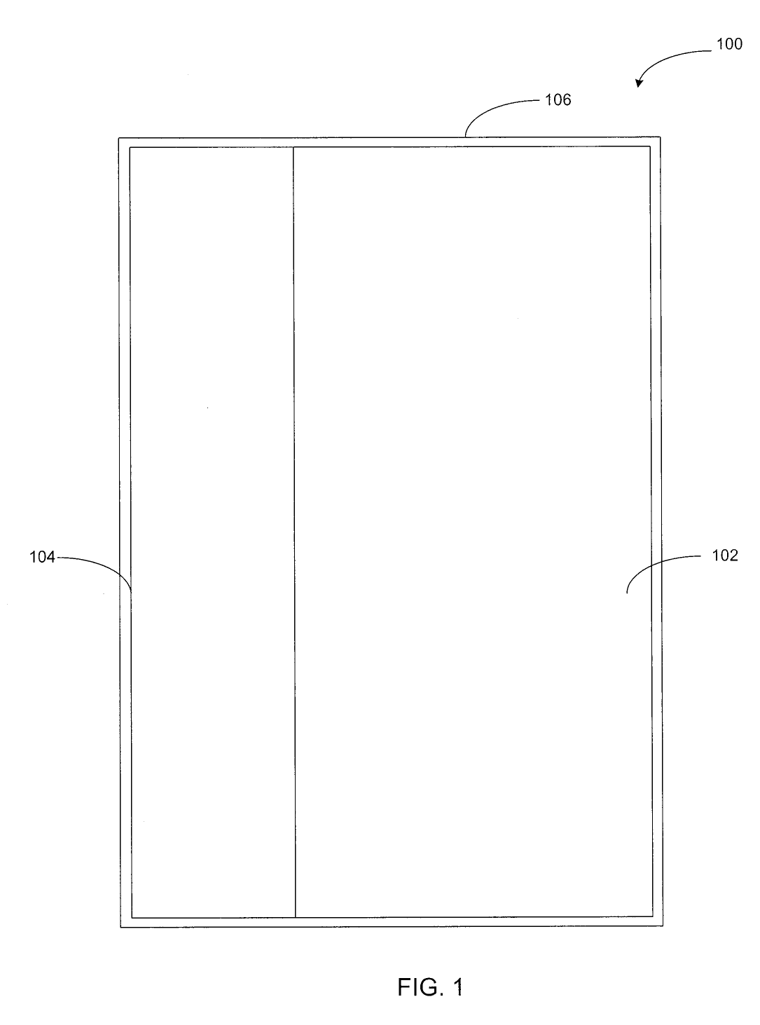

FIG. 1 illustrates a system 100, including a book 102, a storage container 104, and a sleeve or cover 106. System 100 is designed to retain mementoes and to remind individuals to periodically create and/or retain mementoes. System 100 also optionally includes materials to create various mementoes such as letters, photographs, recordings, and the like.

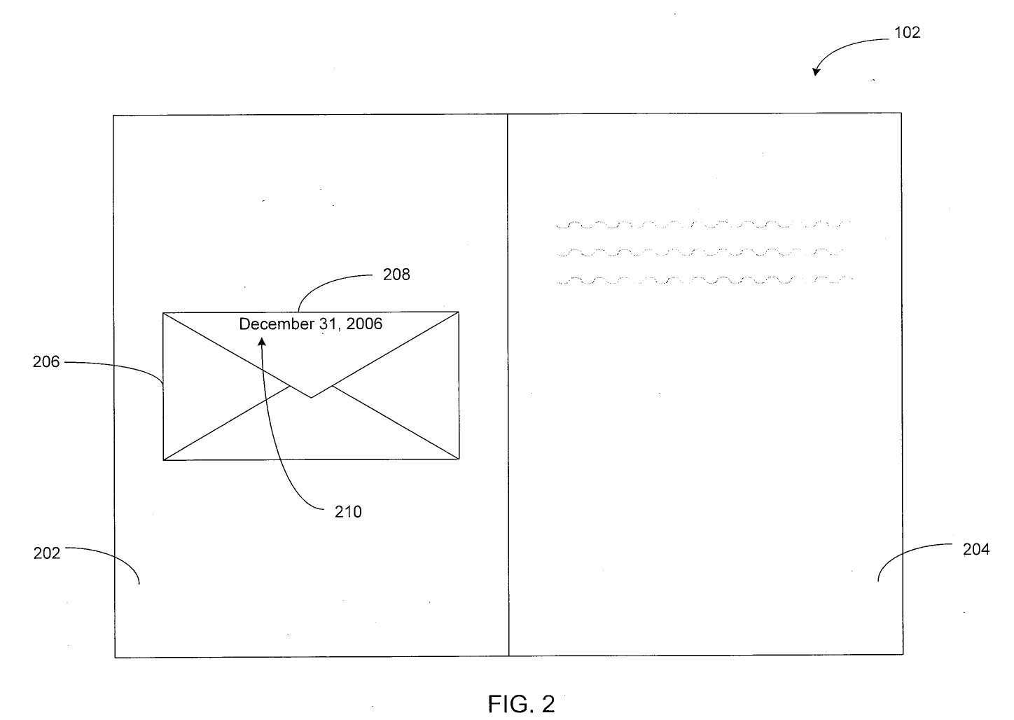

Book 102 is further illustrated in FIG. 2. Book 102 includes multiple sets of adjoining pages 202, 204, one of which includes a compartment 206. Book 102 also optionally includes a pre-printed indicia, such as a date 210 or special occasion corresponding to each compartment. For example, the date may correspond to wedding anniversaries, birthdays, other anniversaries, and the like. If not preprinted, users are encouraged to print corresponding dates on or near compartment 206. In either case, compartment 206 generally corresponds to a specific date or occasion.

In accordance with one aspect of this embodiment, the pre-printed dates correspond to wedding anniversaries, and book 102 preferably includes 50 or more sets of pages. In this case, system 100 can be used to remind married couples to write love letters to each other at least once a year and provides a convenient storage place for the letters. When the book is used by or for children, the book may include 18 sets of adjacent pages and parents, friends, or the children may write letters on or near birthdays, which are conveniently stored within compartment 206.

Book 102 may be configured in a variety of ways. For example, book 102 may be a bound book; a multiple ring binding book, having removable pages; a spiral-bound book; or the like, all with either hard or soft covers. In accordance with one specific embodiment of the invention, the book is a hard-cover book, having a leather exterior, with 50 double-sided pages. However, other cover materials, such as silk, suede, rustic leather, and other book configurations are within the scope of the invention. Additionally, a cover of book 102 may include a pocket—e.g., on a front surface of the book (not shown)—to receive and hold and display items such as photographs or the like.

Pages 202, 204 of book 102 may be formed of any suitable material, such as acid-free paper, water color paper, and the like. Page 203 is preferably configured such that individuals may write on the page and/or attach photographs and/or other memorabilia. For aesthetic purposes, pages 202, 204 may be substantially the same throughout book 102.

Compartment 206 may similarly be formed of any suitable material, such as acid-free paper, water color paper, and the like. Compartments 206 may also be formed in a variety of configurations. By way of example, compartment 206 is an envelope and the corresponding indicia (e.g., date is written on a portion of the envelope (e.g., a flap 208).

In accordance with particular examples of the invention, letters corresponding to the indicia (e.g., a date printed on compartment 206) are stored in compartment 206 and a corresponding photograph (e.g., taken proximate in time to the date on compartment 206) is placed on the opposing page 204.

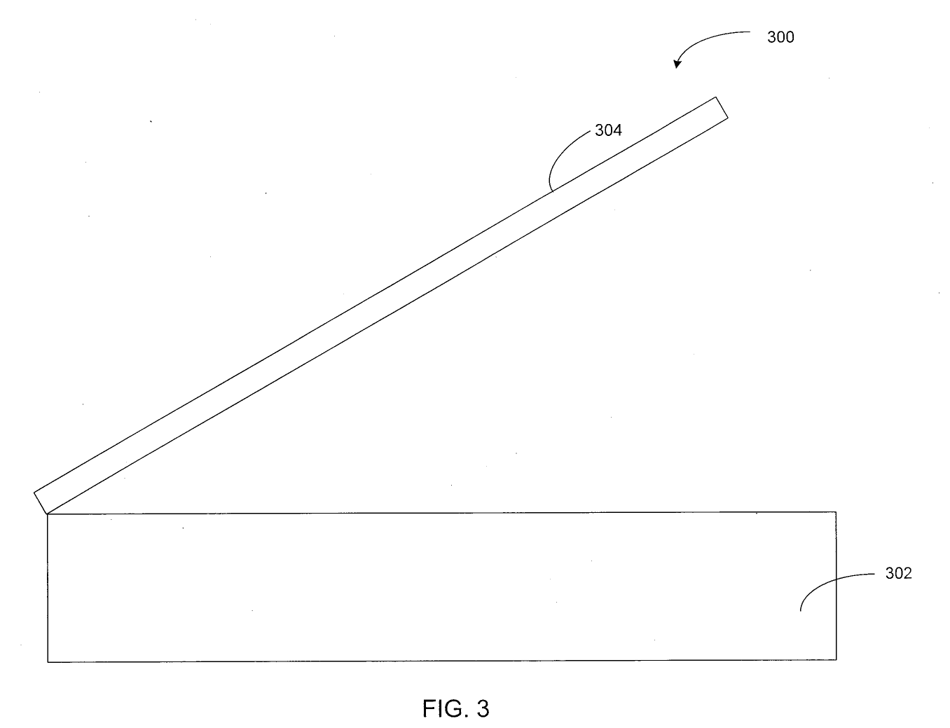

Container 104 may be configured in a variety of ways, such as a flexible folder, a box 300 having a compartment 302 and lid 304 (as illustrated in FIG. 3), a sealable bag, and the like. In accordance with various examples of the invention, container 104 is a box having at least 2 dimensions that are substantially similar to two dimensions of book 102. For example, book 102 may have dimensions of about 8.5″×11″×1.5″ and container 104 may have dimension of about 8.5″×11″×0.75″.

System 100 may also include various items within container 104. In accordance with specific examples of the invention, system 100 includes paper, such that an individual can write on the paper at dates corresponding to indicia 210. The paper may be of any suitable type, such as water color paper, which is preferably acid free. Also, the paper may be scored to facilitate folding the paper along the folds, so that the folded paper will easily fit within compartment 206.

System 100 may also include pens, photographs, photo corners (e.g., acid free photo corners), a gift reminder (e.g., a list of suggested anniversary gifts), recordings, and the like. System 100 may also include a list of suggested topics to write about—e.g., vacations, honeymoons, and may be used to store mailed, but yet unopened, mail.

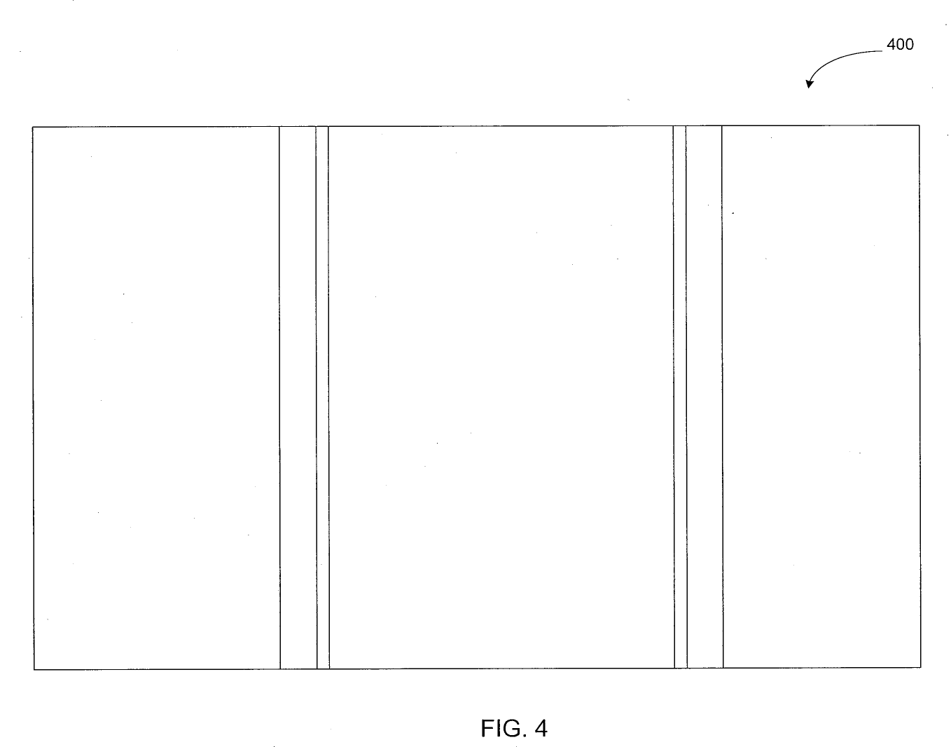

FIG. 4 illustrates a cover 400, for encasing book 102 and container 104, in accordance with another embodiment of the invention. Cover 400 is configured to wrap around three sides of combined book 102 and container 104 (e.g., a first side of the book, a second side of the book, a first side of the container, and a second side of the container). Cover 400 may be secured to book 102 and container 104 by placing a band around cover 400 and securing the band using, for example, buttons, a buckle, a snap, or the like.

In alternative embodiments, book 102 and container 104 may be bound together using a strap and a fastening mechanism, such as buttons, a buckle, a snap, or the like.

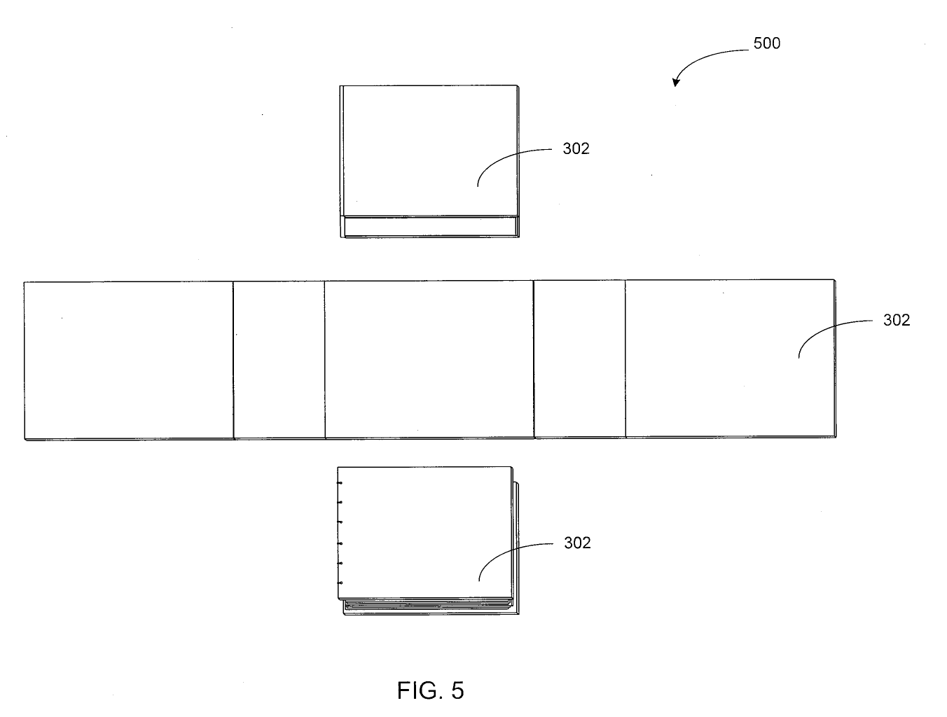

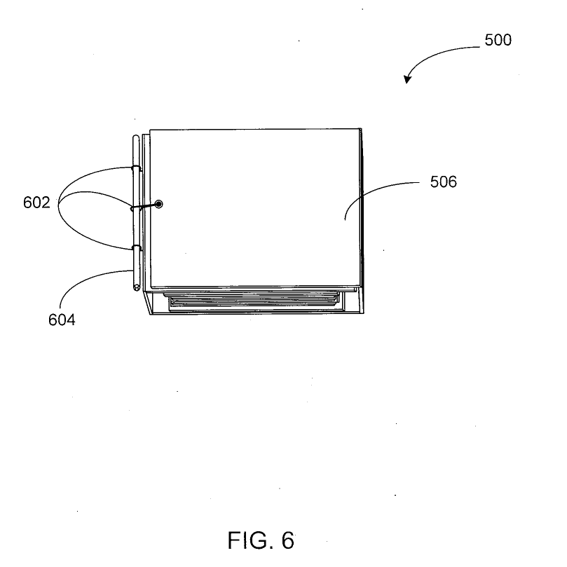

FIGS. 5 and 6 illustrate another system 500 in accordance with various embodiments of the invention. System 500 is similar to system 100, and system 500 includes book 502 and container 504, which are retained within cover 506. As illustrated in FIG. 6, book 502 and container 504 are stored within cover 506 and cover 506 is retained in a closed position using hooks 602 and rod 604. In accordance with one particular embodiment, system 500 is about 7×10.5×2.5 inches.

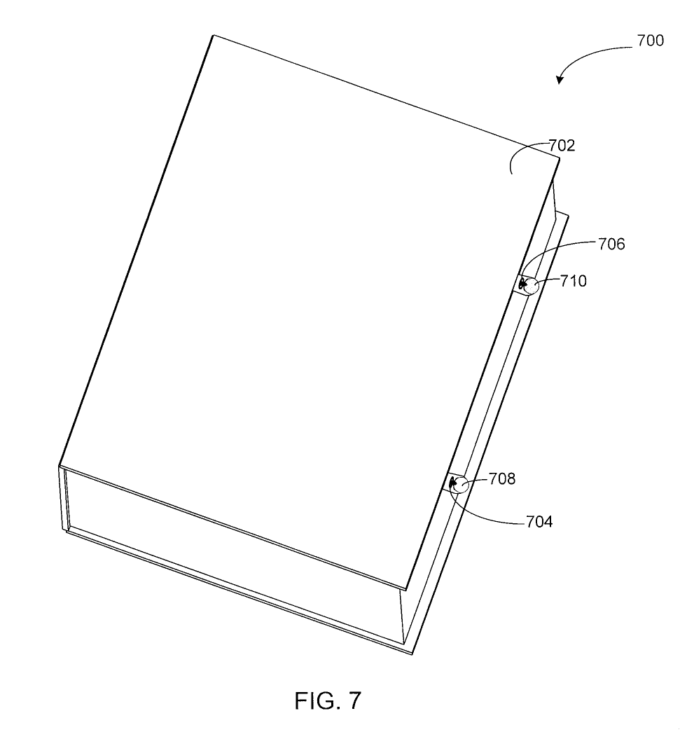

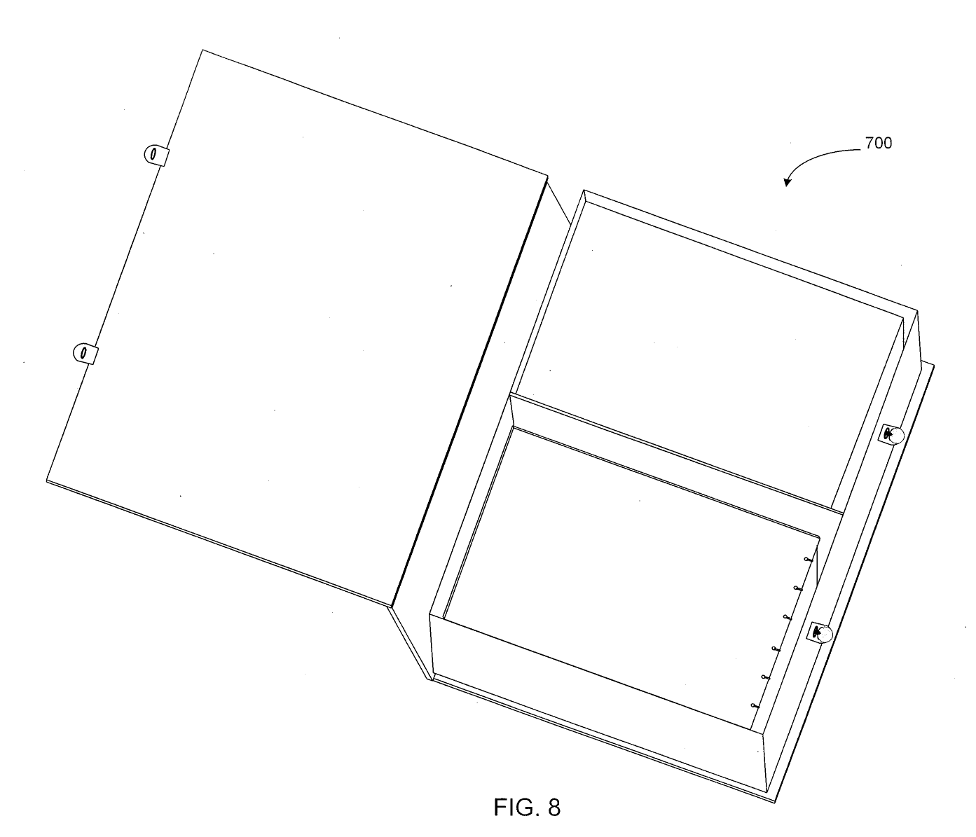

FIGS. 7 and 8 illustrate another system 700 in accordance with yet additional embodiments of the invention. System 700 includes a book 802, a container 804, and a cover 702. Cover 702 is similar to cover 400, except cover 702 includes loops 704, 706, and cover 702 is retained in a closed position by attaching loops 704, 706 around bulbs 708, 710. In accordance with one embodiment, system 700 is about 9.5×14.5×1.75 inches.

The present invention has been described above with reference to a number of exemplary embodiments and examples. It should be appreciated that the particular embodiments shown and described herein are illustrative of the invention and its best mode and are not intended to limit in any way the scope of the invention. Those skilled in the art having read this disclosure will recognize that changes and modifications may be made to the exemplary embodiments without departing from the scope of the present invention.

1. A storage system, comprising:
a storage container; and
a book comprising a plurality of pages, each of the plurality of pages having a first side and a second side, wherein each first side includes a compartment for storing memorabilia, and the compartment includes an indicia corresponding to a predefined date.

2. The storage system of claim 1, wherein the compartment comprises an envelope.

3. The storage system of claim 1, wherein the storage container is a box, having a compartment and a lid.

4. The storage system of claim 3, wherein the lid is coupled to the compartment via a hinge.

5. The storage system of claim 1, wherein the storage container includes one or more items selected from the group consisting of a writing utensil, stationery, a photograph, a photo corner, a charm, a gift reminder list, a recording, and a list of suggested items to write about.

6. The storage system of claim 1, further comprising a sleeve, wherein the sleeve encases a portion of the book and a portion of the container.

7. The storage system of claim 6, wherein the sleeve is fixedly attached to at least one of the book and the container.

8. The storage system of claim 1, wherein the book and the container are substantially the same size in at least two dimensions.

9. The storage system of claim 1, further comprising a strap to bind the book and the container.

10. The storage system of claim 1, wherein the predefined date is selected from the group consisting of anniversary date and birth date.

11. A system for storing memorabilia, the system comprising:
a container;
a book having a plurality of pages, each of the plurality of pages having a first side and a second side, wherein each first side includes a compartment for storing memorabilia and an indicia comprising a predefined date; and
a sleeve encasing at least a portion of the container and the book.

12. The system for storing memorabilia of claim 11, wherein the sleeve is fixedly attached to at least one of the container and the book.

13. The system for storing memorabilia of claim 11, wherein the compartment is an envelope.

14. The system for storing memorabilia of claim 11, wherein the container includes one or more items selected from the group consisting of a writing utensil, stationery, a photo corner, a photograph, a charm, a recording, a gift reminder list, and a list of suggested items to write about.

15. The system for storing memorabilia of claim 11, wherein the book is a hard cover book.

16. The system for storing memorabilia of claim 11, further comprising a pocket on a front surface of the book.

17. The system for storing memorabilia of claim 11, wherein the plurality of pages comprise acid-free paper.

18. The system for storing memorabilia of claim 11, wherein the plurality of pages comprise water color paper.

19. The system for storing memorabilia of claim 11, further comprising a strap.

20. A method of storing memorabilia and recording memories, the method comprising the steps of:
providing a system comprising a storage container and a book, the book comprising a plurality of pages, each of the plurality of pages having a first side and a second side, wherein each first side includes a compartment for storing memorabilia and an indicia corresponding to a predefined date;
inserting materials relating to the predefined date into the compartment; and
attaching materials relating to the predefined date to the second side.
